(19) United States
(12) Patent Application Publication
(10) Pub. No.: US 2019/0251058 A1
(43) Pub. Date: Aug. 15, 2019

(54) RECONCILING DATA SETS

(71) Applicant: PIONEER SQUARE LABS, INC., Seattle, WA (US)

(72) Inventors: Sean Robinson, Burien, WA (US); Daniel Gorrie, Seattle, WA (US); Glenn Wisegarver, Sammamish, WA (US); Adam Dean Loving, Seattle, WA (US)

(21) Appl. No.: 16/015,086

(22) Filed: Jun. 21, 2018

Related U.S. Application Data
(60) Provisional application No. 62/628,473, filed on Feb. 9, 2018.

(51) Int. Cl. G06F 15/18; G06K 9/62; G06Q 40/06

(52) U.S. Cl. CPC G06F 15/18; G06K 9/6256; G06Q 40/06; G06K 9/6267; G06K 9/6201

(57) ABSTRACT

Disclosed is a reconciliation system which implements a two-stage reconciliation process. During a Training Stage, useful features of training data are identified and used to generate a machine learning model. When new data is provided which requires reconciliation, a Classification Stage uses the machine learning model to first aggregate the new data into tranches of candidate matches based on the useful features. Then, records within each tranche may be matched in a much more efficient manner.

### CROSS REFERENCE TO RELATED APPLICATIONS

This patent claims priority to and the benefit of co-pending U.S. Provisional Patent No. 62/628,473, filed on Feb. 9, 2018, entitled “Reconciling Entries Between Two Data Sets” the disclosure of which is hereby incorporated by reference for all purposes as if set forth here in its entirety.

### BACKGROUND INFORMATION

One common task that must be performed by businesses is the reconciliation of data. Various business functions, such as Finance & Accounting and Operations, all require data of some sort to be reconciled. A major responsibility of business professionals is ensuring that a company's books are complete and balanced. However, reconciling data is a very time consuming and error prone task.

There have been many attempts at creating reconciliation solutions that can automate the process and eliminate or at least reduce human error. Complex software systems, such as Enterprise Resource Planning (ERP), commonly have components that assist with reconciliation while others are stand-alone. However, existing systems are still prone to reconciliation difficulties and require significant manual intervention. Although existing systems may reduce the amount of manual time necessary to reconcile two data sets, they still require significant manual effort to set up in advance.

Business operations are complex and often require separate systems. It is also common for separate systems to interface with the ERP. The use of separate systems means the data type, format, and content may be different, which further complicates reconciliation. Examples include medical invoicing systems, financial (bank) loan systems, time-keeping systems, credit card processing system, and the like. Even within ERP systems, data type, format and content may be different between modules, leading to additional complexity. For that and other reasons, existing reconciliation solutions require significant manual effort to set-up and maintain, and may still need significant human intervention to accomplish reconciliation.

For those and other reasons, existing automated reconciliation systems are inadequate to meet the needs of the business professionals. These limitations result in staff expending large amounts of time on routine and rote tasks. Manual reconciliations are highly prone to human error. And the business professionals lack technical or other process safeguards, traceability, & auditability.

An adequate system for reconciling entries between related data sets has eluded those skilled in the art, until now.

### SUMMARY OF EMBODIMENTS

This disclosure is generally directed to a system for reconciling data in two or more related but different data sets. Embodiments of the reconciliation system implement a two-stage reconciliation process. During a Training Stage, useful features of training data are identified and used to generate a machine learning model. When new data is provided which requires reconciliation, a Classification Stage uses the machine learning model to first aggregate the new data into tranches of candidate matches based on the useful features. Then, records within each tranche may be matched in a much more efficient manner.

### BRIEF DESCRIPTION OF THE DRAWINGS

FIG. 1 is a conceptual overview of a computing environment in which is implemented a reconciliation system in accordance with this disclosure.

FIG. 2 is a conceptual diagram of two representative data sets that may be reconciled using embodiments of this disclosure.

FIG. 3 is a conceptual diagram of a worksheet demonstrating a bunch of things done to identify “hard matches,” in accordance with embodiments of the disclosure.

FIG. 4 is a logical flow diagram generally illustrating a process performed by the reconciliation system, shown in FIG. 1, to match entries in one data set with corresponding entries in another data set, in accordance with one embodiment of this disclosure.

FIG. 5 is a functional flow diagram generally illustrating a Training Stage step performed by one preferred reconciliation system in accordance with the teachings of this disclosure.

FIG. 6 is a functional flow diagram generally illustrating a Classification Stage step performed by one preferred reconciliation system in accordance with the teachings of this disclosure.

FIG. 7 is a functional block diagram of an illustrative computing device that may be used to implement various embodiments of this disclosure.

### DETAILED DESCRIPTION

This disclosure teaches a system for reconciling entries in related data sets. Generally stated, embodiments of the disclosure implement a reconciliation system that can match records in one data set with corresponding records in another data set, such as financial ledgers or the like. In a preferred embodiment, the reconciliation system includes components to reconcile data sets in a two-stage operation. Generally stated, the two stages are a training stage and a classification stage. The preferred embodiment is implemented as a specially programmed computing device having components for reconciling related data sets. This disclosure is structured with a discussion of one example computing device specially configured to implement the reconciliation system first, followed by a discussion of functional operations performed by one preferred embodiment.

Various embodiments are described more fully below with reference to the accompanying drawings, which form a part hereof, and which show specific exemplary implementations for practicing this disclosure. However, other embodiments may be implemented in many different forms and should not be construed as limited to the embodiments set forth herein; rather, these embodiments are provided so that this disclosure will satisfy formal statutory requirements. Embodiments may be practiced as methods, systems, or devices. Accordingly, embodiments may take the form of a hardware implementation, an entirely software implementation, or an implementation combining software and hardware aspects. The following detailed description is, therefore, not to be taken in a limiting sense.

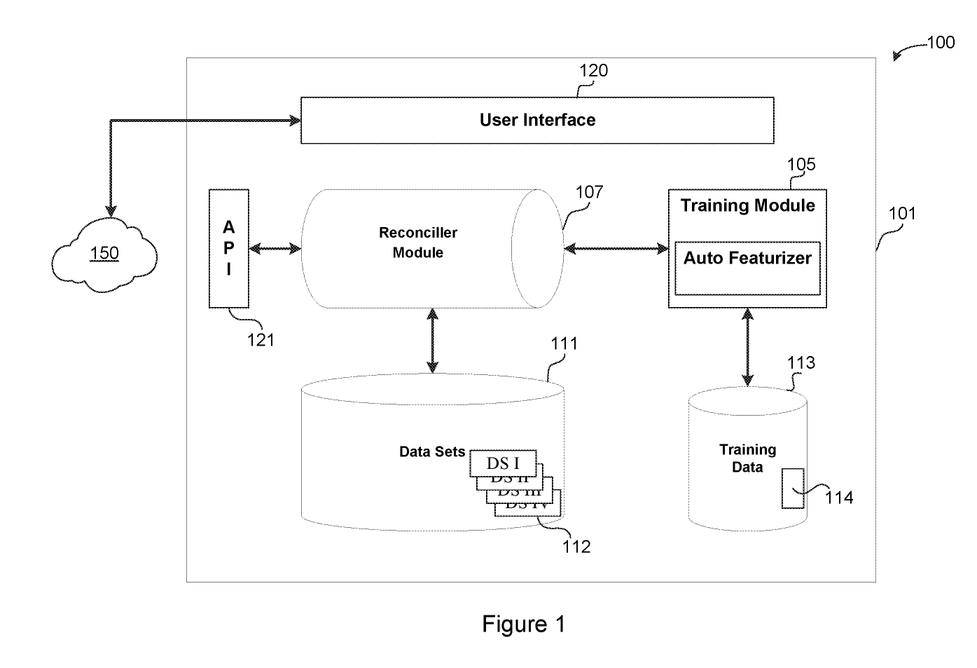

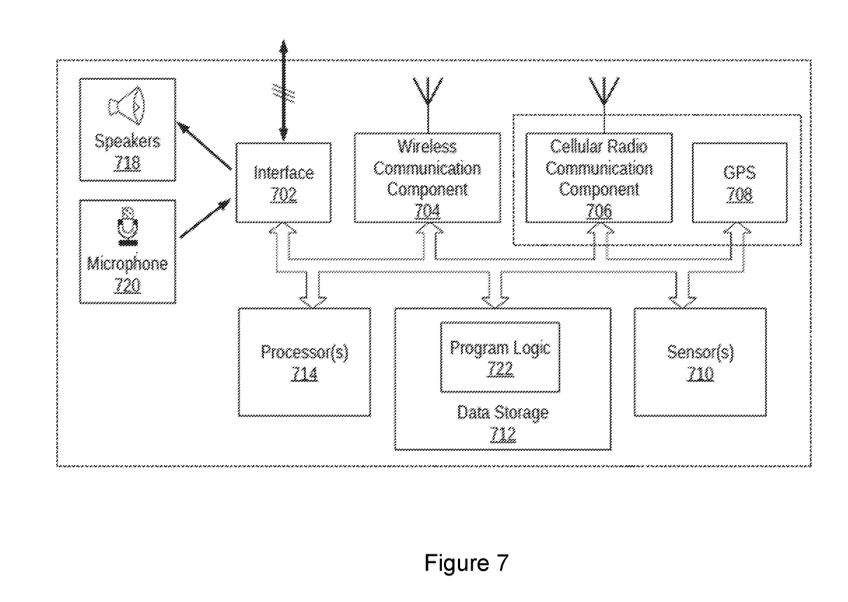

The logical operations of the various embodiments are implemented (1) as a sequence of computer implemented steps running on a computing system and/or (2) as interconnected machine modules within the computing system. The implementation is a matter of choice dependent on various considerations, such as performance requirements of the computing system implementing the embodiment. Accordingly, the logical operations making up the embodiments described herein may be referred to alternatively as operations, steps or modules. Turning now to the drawings, FIG. 1 is a conceptual diagram of a computing environment 100 in which is implemented a reconciliation system 101 in accordance with this disclosure. The reconciliation system 101 is preferably implemented as a computing device, such as, for example, the computing device 701 illustrated in FIG. 7 and described below.

The preferred reconciliation system 101 includes a training module 105 and a reconciler module 107, a first data store 111, and a second data store 113. In operation, the reconciliation system 101 operates in a Training Stage and a Classification Stage, which will be described below. Although described generally as two distinct stages, it should be appreciated that there may be significant overlap between the two stages, and portions of either stage may be incorporated into the other.

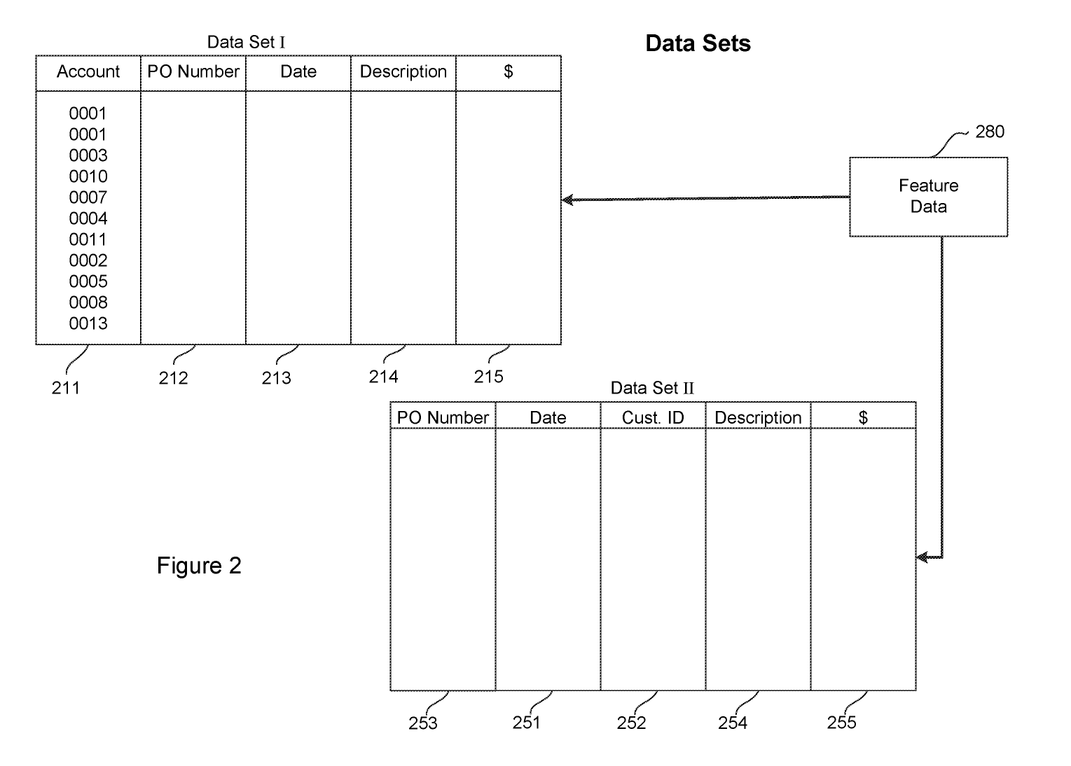

The first data store 111 contains related but different data sets. In one specific preferred embodiment, the different data sets include financial ledgers, such as expenditures and revenue, that must (or should) be reconciled. In other words, entries in one data set must be matched to corresponding entries in another data set. One simple example may be entries in a general ledger that indicate funds expended by a company, and entries in an account ledger that indicate withdrawals from a bank account. In such a case, both ledgers must have corresponding entries to ensure a proper audit trail and record keeping. More detailed examples of data sets that may be contained in the first data store 111 are illustrated in FIG. 2 and described below.

The second data store 113 holds training data 114 that may be used by the reconciliation system 101 to help identify matches between entries in related data sets 112. The training data 114 may include “known good” matches between two sample data sets (training data sets). In other words, two training data sets may be provided, such as by a customer of the reconciliation system, together with information that identifies correct matches between the two training data sets.

The training module 105 includes functions and routines to analyze the training data 114 to determine “features” (as defined below) of entries within data sets that correspond to “known good” matches between entries in the two data sets. For the purpose of this disclosure, the term “known good” refers to a match between an entry in one data set and a corresponding entry in another data set that is known to be an actual match, such as by manual confirmation. Those functions and routines of the training module 105 may be referred to herein as an “Auto-Featurizer” 106. The operations performed by the Auto-Featurizer 106 may vary between the Training Stage and the Classification Stage. Generally stated, the Auto-Featurizer 106 performs two operations: Feature Production and Feature Reduction. In the most preferred embodiment, Feature Production is a process of comparing fields in a record in one match pair with one or more fields (possibly all fields) in the corresponding match pair record of the other data set to produce transformations and comparisons (as an example, “column 1 of source 1 minus column 5 of source 2” would be possible, as would other sorts of distance calculations and comparisons). Many such combinations are possible, and the results of those comparisons are referred to herein as “features” of the match pair records or data sets.

Feature Reduction, in the most preferred embodiment, is a process of determining any “useful features” produced by Feature Production. For the purpose of this discussion, the term “useful features” means features of matched pairs of records that are identified as being an indicator of a match (or the absence of a match) between records in one data set with records in another data set. These two processes together may constitute core, but not necessarily all, functions of the “Auto-Featurizer.”

In the Training Stage, the Auto-Featurizer 106 may perform Feature Production and Feature Reduction to identify useful features. In the Classification Stage, the useful features are already known, so the features are simply constructed again for unmatched data from the known useful features. Although described broadly here, specific embodiments and implementations of the operations performed by the Auto-Featurizer 106 are described below in conjunction with FIGS. 2, 3, 5 and 6.

A user interface 120 may be used to allow a user to interact with and operate the reconciliation system 101. For example, the user interface 120 may enable a user to upload training data 114, or data sets 112, or both. Generally stated, the user interface 120 allows human override and control of the reconciliation system 101. In addition, the user interface 120 may allow human interaction—during the Training Stage, the Classification Stage, or both—to provide additional training data 114 or to resolve conflicts that may occur during reconciliation. This allows improvement and automatic retraining after any reconciliation performed by the reconciliation system 101, thus allowing for gradual drift in the contextual meaning of data sets.

The reconciliation system 101 may, optionally, expose an Application Programming Interface (API) 121 to allow programmatic access to the functionality provided by the reconciliation system 101. In this way, the reconciliation system 101 may be implemented as a cloud-based Software-as-a-System (SaaS) offering. Additionally, providing different APIs 121 for each subsystem may further allow modular construction and system scaling. The API 121 allows customer interface and integration into more complex or bespoke toolsets.

The reconciliation system 101 couples to a wide area network 150, such as the Internet or a private intranet, for communication with other computing devices. This allows remote users to connect to the reconciliation system 101 either with the user interface 120 or using the API 121.

FIG. 2 is a conceptual diagram of representative data sets that may benefit from, or be used in, embodiments of this disclosure. As noted above, in the most preferred embodiment, the data sets (e.g., “Data Set I” and “Data Set II”) represent tables of data structured in columns and rows, where each row represents a single record. Each record constitutes an entry in the data set. The several columns represent various categories of information stored in the table. For example, Data Set I may be a general ledger in which each record represents a particular expense paid by a company. In such an example, Data Set I may include columns such as an account number 211, perhaps a purchase order number 212, a date 213, a description 214, and an amount 215. Data Set II may be a bank account ledger in which each record represents a debit to the company's bank account. In such an example, Data Set II may include columns such as a date 251, a customer ID 252, perhaps a purchase order number 253, an account number 254, and an amount 255.

In another example, Data Set I could come from a credit card point-of-sale (POS) system and Data Set II could be associated with a credit card payment gateway (or payment processor, or bank, etc.). In yet another example, Data Set I may come from a hospital billing system in which invoices are compared against other data sets (Data Set II) such as multiple counter-party systems—e.g. private insurance company, Medicare, government, a bank lockbox, or the like.

It will be apparent that these columns for both Data Set I and Data Set II are representative only, and many other columns may be present without deviating from the spirit of this disclosure.

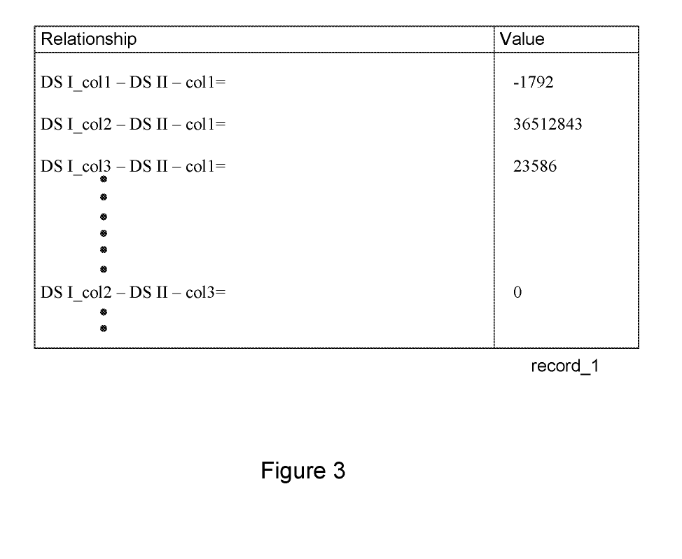

In accordance with various embodiments, feature data 280 may be present to identify useful features of data stored in the two data sets. Again, useful features constitute information that describes criteria that is substantially dispositive of the existence of a match (or absence of a match) between a record in Data Set I and a record in Data Set II. The feature data 280 may be created during the Training Stage and used during the Classification Stage to help reconcile Data Set I with Data Set II. One embodiment of a preferred process for the creation of feature data 280 is illustrated in FIG. 3 and described below.

FIG. 3 is a conceptual diagram of a worksheet demonstrating types of comparisons that may be performed to identify useful features of data sets, in accordance with one embodiment of the disclosure. As noted above, useful features are features of matched pairs of records that are identified as being an indicator of a match (or the absence of a match) between records in one data set with records in another data set.

In one embodiment, a training module may accept training data, in which at least two data sets (e.g. the data from two systems) are provided having known good matches between the sets. In other words, each record in one data set has already been matched to a corresponding record in another data set. In this embodiment, the training module performs algebraic operations, such as additions or subtractions or both, on fields in both matched records. Many similar column manipulations may be made in this embodiment, including the comparison of record elements that are strings or have string elements within them, or the isolation and independent comparison of commonly-expected string elements such as the last 4 digits of credit card or other financial records. The result of each algebraic (or other) operation may be considered a feature of matching records. For example, referring to FIG. 2, the training module may add the account field 211 in Data Set I to the data field 251 of Data Set II, and the account field 211 of Data Set I to the customer ID field of Data Set II, etc. The value of each algebraic operation (the feature) is examined to determine whether it is useful in identifying matches.

For example, referring to FIG. 3, the training module may identify features including the difference between column 2 of Data Set I (purchase order 212) and column 3 of Data Set II (purchase order 253). Thus, the difference between purchase order 212 and purchase order 253 becomes one feature of that matched pair. We may refer to this as the “purchase order feature.” In this example, that difference is zero (0) meaning that the values in each field are the same. This operation is repeated for every matched pair in the data sets and the various features are stored for evaluation.

To account for matches that involve multiple records (e.g. matches where two or more records from one data set collectively match with one record from the other data set), the features produced by this method also either sum, or average, the data columns used to produce the features. In this way, the same feature sets can be constructed from matches between one record from either data set, or multiple records from either data set.

A (generally large) set of possible features is generated in this way from the training data. In addition, non-matches are produced by randomly selecting data records in the same style as the existing matches, to produce contrasting “non-matching” combinations of records and corresponding features that represent a “non-match.” Once a sufficient number (which could be, but need not be, all) of matched pairs have been determined, those features are evaluated to identify any correlations between features and matches. For example, it may be that for all matches the purchase order feature is zero, while for non-matching record combinations the same purchase order feature varies greatly. Thus, the training module may conclude that unless the purchase order fields of entries in two different data sets are equal, those entries cannot be a match. Thus, the purchase order feature becomes a useful feature in identifying matches.

Features that display strong variance between “matching” and “non-matching” data record combinations are considered “useful” to determine matching status, and are further broken into several groups. Features that represent a necessary requisite rule that must be satisfied in every match are referred to as “tranching features” and will be used by later stages to tranche data into smaller “candidate match” groups. Features that contain strong differences between matching and non-matching data configurations are referred to as “matching features” and are used by later stages to evaluate match status of data records in the traunched data, either directly by evaluation of the feature value or by using a machine learning stage. Useful features are stored by the system for later use in two ways—the features themselves, along with their expected distributions for matching and non-matching examples are stored directly, and also used as the input features for a machine learning classification model trained on the matching and non-matching examples. Both methods can be used by the classification stage to provide confidence in candidate matches.

FIGS. 2 and 3 have been used to introduce the concept of identifying useful features to assist in reconciling data sets. The following discussion details processes that may be used to implement specific embodiments.

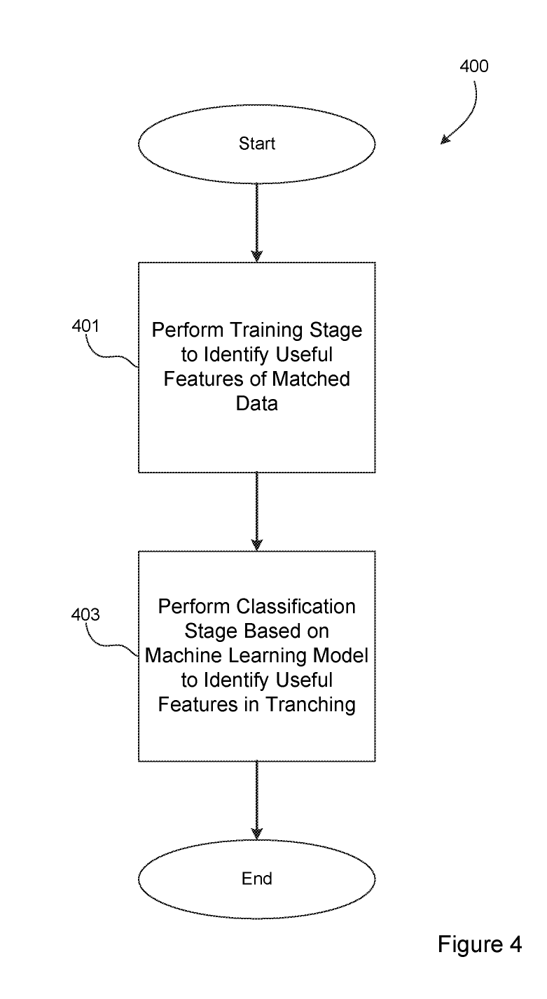

FIG. 4 is a logical flow diagram generally illustrating a process 400 performed by the reconciliation system, shown in FIG. 1, to match entries in one data set with corresponding entries in another data set, in accordance with one embodiment of this disclosure.

At step 401, the reconciliation system performs a Training Stage. As noted above, during the Training Stage 401 training data is examined to identify usable features of matched records. The training data may come from, for example, a human-reconciled pair of data sets. The data sets include records, such as financial transactions, that have been reconciled.

Data features are produced from the training data that may reveal a correlation between two or more columns in the pair of data sets and a match between entries in the data sets. This process may be termed “featurizing” the training data. Useful features represent features that are determined to correspond to a match between two entities. As noted above, features that display a strong difference between the “matching” and “non-matching” training data will be considered useful. The useful features can be used to create models for use in classification (i.e. record matching) on data sets that require reconciliation.

At step 403, the reconciliation system performs a Classification Stage. During the Classification Stage, unmatched data sets of records are provided by a customer or user. In this example, the unmatched data sets include records of transactions that were recorded using the same structure as the data sets provided during the Training Stage 401. In one example, the unmatched data sets include records of financial or business transactions that must be reconciled.

The unmatched data sets are evaluated to identify the same or similar features as during the Training Stage. Wth those features identified, the reconciliation system uses the models developed during the Training Stage 401 to classify groups of records as “matching” or not. Generally stated, the Classification Stage 403 first identifies, using the useful features identified during the Training Stage 401, any record pairs or groups of record pairs which either cannot be a match because they would violate the information identified by the useful features, or record pairs or groups of record pairs which are likely to include matched pairs based on the useful features information.

This operation drastically reduces the number of brute-force reconciliations that must be performed, resulting in a significant time savings over other techniques. More specifically, the number of records provided in two (or more) data sets that need reconciliation could be in the thousands, tens of thousands, or hundreds of thousands per data set. Attempting to perform unique reconciliation comparisons of each record in one data set against every record in another data set becomes a computational problem of significant burden. The useful “tranching features” identified in the Training Stage enables the number of record comparisons between data sets to be drastically reduced; from thousands compared against thousands to perhaps tens compared against tens. To accomplish this, the tranching features are used to group (i.e., tranche) data into smaller sets, each of which will be internally evaluated to find matches, but where no cross-tranche matches are expected due to the strength and specificity of the discovered tranching features.

With the records appropriately categorized into tranches based on the useful features, the Classification Stage 403 may then perform comparisons of records within each tranche to identify actual matches. Within each tranche, combinations of records are produced by making possible combinations between the two data sets to be reconciled, then evaluating each one. This evaluation is either performed by the machine learning classifier trained in the training step, or by comparing the useful “matching features” from the training step directly with the calculated features of each record combination. In the former approach, the machine learning classifier is directly queried to produce a probability of match. In the latter, an average scaled feature “distance” is calculated from the features calculated for the candidate match and the average feature value from the matches in the training set. In each case thresholds are applied against the match probability to provide a best set of matched records. Any records which remain unmatched after the Classification Stage 403 is complete may be presented to a user for manual reconciliation or confirmation no match is expected.

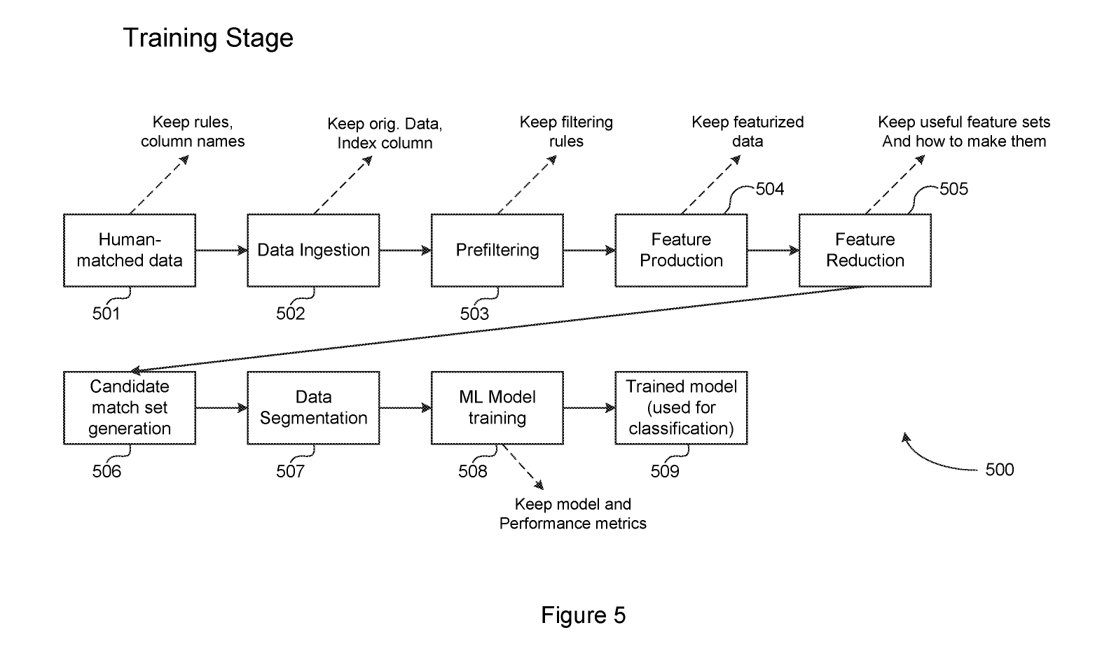

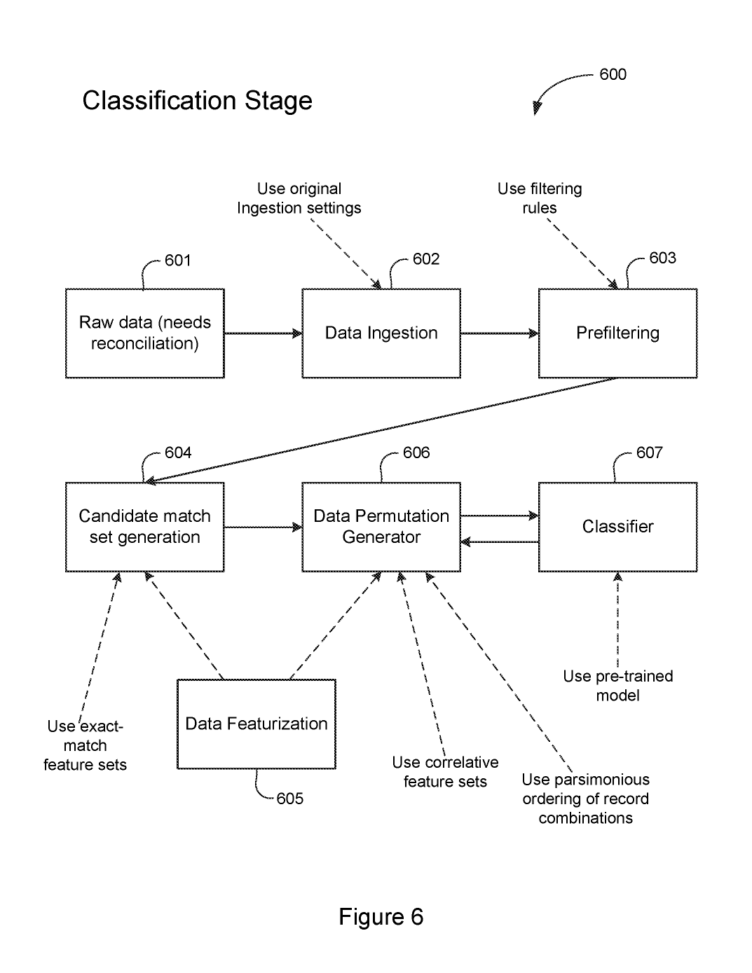

Accordingly, the process 400 shown in FIG. 4 provides a high-level overview of the two stages of operation of the preferred reconciliation system. This approach uses a train-once, then train-iteratively approach to keep the model well-tuned to the problem space. In this approach, the human-verified results from previous reconciliations may be added to the training data and the training stage performed again to allow for new dynamics that may vary over time. Specific implementations of operations that may be performed at each step will now be described in conjunction with FIGS. 5 and 6.

FIGS. 5 and 6 are functional flow diagrams generally illustrating the steps performed by the reconciliation system of this disclosure. FIG. 5 is a functional flow diagram generally illustrating steps performed to train the reconciliation system (the “Training Stage”). FIG. 6 is a functional flow diagram generally illustrating steps performed to reconcile disparate data sets that require reconciliation (the “Classification Stage”). Several operations are the same or similar in both the Training Stage 500 and the Classification Stage 600. However, there are also a few distinctions between similar steps in the two stages. Accordingly, the Training Stage 500 will be discussed first, followed by a discussion of the Classification Stage 600.

Turning first to FIG. 5, the Training Stage operates to train the reconciliation system on data that has been previously reconciled. For example, two related data sets, such as financial ledgers, have been previously reconciled such that each record in one data set has a match partner in the other data set. The initial reconciliation may have been manually performed, or may have been performed using any other technique.

The Training Stage begins when training data is provided to the reconciliation system (step 501). As noted, the training data includes known-good data sets that have been previously reconciled such that the reconciliation system has available information identifying one or more entries in a first data set that are known to match one or more entries in the second data set.

At a data ingestion step (502), customer data sets are input into the reconciliation system. In certain embodiments, records may be in multiple files, or be separate columns in the same file as a distinguishing set of names indicating which columns came from which source, and a “match” column describing which records have been shown previously to match one another. As part of data ingestion, a unique identifier (UID) is added to the data sets so that each unique record may be identified.

At a pre-filtering step (503), user-defined rules (and additional system-derived policies) may be used to standardize and perhaps expand the data sets. For instance, date fields may be converted to standard format, monetary values may be converted to a standard format, and the like. Ad-hoc rules may also be written at this point to allow for construction of known fields of interest (e.g., a separate month and year field being made into a standardized date which is then added). “Industry Standard” fields may be added, such as the last 4 digits of any numeric string, the concatenation of numeric elements in a string, etc. This allows standard fields (e.g., the last four digits of a credit card or SSN) to be compared automatically later. During the Training Stage, a set of example matches may be produced (by matching the user-generated match column and non-matches (by randomly selecting non-matching data).

At a feature production step (504), examples of matching records may be paired with examples of non-matches (constructed by randomly combining non-matching records together). In one particular embodiment, for each column of data, all permutations (or a significant number of permutations) of algebraic combinations of columns are produced, such that they form a combination of the data sources to be matched. For instance, algebraic combinations may take the form “The sum of all columns B from data source 1, minus the sum of all columns D from data source 1, plus the sum of all columns G from data source 2.” These algebraic combinations can be performed on one-to-one matches (e.g., column B from data source 1 minus column G from data source 2) or more complex permutations (e.g., “column B minus columns C and G,” etc.).

During the feature production step 504, user-input features may also be introduced, in addition to those automatically determined by the reconciliation system. A string-distance (e.g. edit distance) technique or a word frequency technique (e.g. TF-IDF) may also be used to create string similarity. Combinations are added to the existing data to create examples of each feature in matching and non-matching conditions. Matches and non-matches are reproduced for training by keeping existing matches and identifying non-matches by, for example, randomly permuting records within the candidate match set, and a (generally high) number of featured are created in this feature production step for both the matching and non-matching cases.

At a feature reduction step 505, for every feature identified (or provided) during feature production 504, the reconciliation system examines distributions with respect to matched state. In one embodiment, features are “ranked” according to one of several metrics. For example, features may be ranked based on a ratio of standard deviations of their distributions between matched and unmatched state. Alternatively, features may be ranked using a supervised machine learning algorithm that allows calculation of feature importance (e.g. Random Forests). In one preferred embodiment, features are grouped based on discriminatory power. It is envisioned that most features will have no discriminatory power (i.e., matched and non-matched distributions are similar, as expected in the case where unrelated columns are combined in a feature). These features may be deemed “unrelated” and discarded. However, for some features, the deviation in matches will be nearly 0 (e.g., when columns must match exactly for there to be a record match, as expected in the case of matching transaction IDs together, etc). These “exact matches” are stored for use later. These features are stored as a set of column pairs that are identified as “must be equal” or a rule describing the necessary relationship. For the remaining features, some correlation is present but is not a perfect match. These “correlative matches” may also be stored for use later.

At a candidate match set generation step 506, the data is broken into “candidate matched groups” using the exact-match features. Data records that match according to these exact-match features are grouped together. Many small subgroups are produced in this way, from which matches must derive.

At a data segmentation step 507, examples of matching and non-matching data may be separated into a training set and a much smaller “testing set” to allow for training a generalizable model/technique and to verify that model's effectiveness.

At a machine learning model training step 508, one or more models are trained on any remaining indicative relationships (e.g., the “useful features”). In one preferred embodiment, only the remaining unused features (i.e. useful features not already used to produce the data tranches) are included in these models. In one preferred embodiment, a best ensemble of features may be chosen according to performance (i.e. Feature importance for producing an accurate match classification), and kept together with a trained algorithm to classify match/non-match status on future candidate record combinations.

At a training model output step 509, the reconciliation system outputs the training models created during the Training Stage 500 for use in future reconciliations. At this point, the reconciliation system is trained and ready to perform reconciliations on data sets that are similar in structure to the training data sets.

Turning next to FIG. 6, the Classification Stage 600 operates to perform an actual reconciliation against live data in two or more related but different data sets.

The Classification Stage 600 begins when raw (unmatched) data is provided to a reconciliation system at step 601. The raw data includes at least two data sets that require reconciliation. The raw data sets are structured similar to training data sets that were used to train the reconciliation system.

At a data ingestion step 602, the raw data is input into the system. Records within the data sets may be either in multiple files, separate columns within the same file, or within the same columns but with a distinguishing “source” column. As with the Training Stage 500, the raw data is standardized in this step, known (e.g., user input) unimportant columns may be removed, and a unique identifier (UID) may be assigned to each record.

At a pre-filtering step 603, optimal user-defined rules (and additional system-derived policies) may be used to standardize and slightly expand the data set. For instance, date fields may be converted to a standard format, ‘Industry Standard’ fields may be added (e.g., the last 4 digits of any numeric string, the concatenation of all numeric elements in a string, etc.). This allows standard things (e.g., the last digits of a credit card or SSN) to be compared automatically. Once any additional columns have been created, the data proceeds to data featurization 605, which includes feature production. During the Classification Stage, feature production proceeds in a similar fashion as during the Training Stage 500. However, in the Classification Stage 600, since useful features are already known (e.g. from the Training Stage 500), the reconciliation system only needs to produce the useful features of the data.

At a candidate match set generation step 604, the data is broken into “candidate matched groups” (e.g., tranches) based on the useful features data discovered during the Training Stage 500. For instance, records whose features satisfy the exact-match features from the Training Data may be grouped together, and records which satisfy the correlative match features may be grouped together. Many small subgroups of the data are produced in this way, from which actual matches may be identified.

Dividing the entire universe of data records into tranches based on useful features allows for much smaller and more human-accessible groupings for manual matching. In addition, it allows for automatic matching to attempt much higher-order matches (e.g. 3-to-1-record matches or higher) without resulting in a computationally prohibitive number of required comparisons.

At a data permutation generator step 606, once the data is broken into smaller “candidate match” tranches using the useful features, the reconciliation system constructs a permutation generator that attempts to find all matches in a parsimonious, low-record-order manner first. For example, in one specific embodiment, the reconciliation system may construct 1-to-1 (1×1) matches of records from each data source within a 63×10 candidate group, find expected matches with the machine learning stage, repeat until no 1×1 matches are left, then try 2×1, 1×2, 63×10, and other match sizes ordered by the number of combinations until a complexity threshold is met or the entire group has been investigated.

At a classifier step 607, each potential match may be checked via the trained machine learning stage, or by directly comparing each feature with the expected value of matches. Either of these methods may be used to produce a probability of match, which may be compared with a user defined threshold to identify stated matches. As each correct match is removed from the candidate group, the process continues until no 1×1 matches are possible. Other match sizes are constructed as the candidate group shrinks, which operates to reduce the number of total permutations and computational complexity. A full set of matches, probabilities, reconciling items and remaining candidate groups may be delivered to the user, such as via a user interface or API.

Embodiments of the foregoing disclosure may be implemented using one or more computing devices. The computing devices in which embodiments are implemented may take one or more of several different configurations. For instance, physical computing hardware may be used as well as virtual computing environments. In addition, both fixed location and mobile devices may be used. Any combination of computing devices may be used to implement embodiments. However, once implemented, the embodiments of this disclosure transform the host computing device into a special purpose machine specially configured to accomplish the goals of this disclosure.

By way of example, FIG. 7 illustrates an example computing device 700. In some examples, components illustrated in FIG. 7 may be distributed across multiple computing devices. However, for the sake of example, the components are shown and described as part of one example computing device 700. The computing device 700 may be or include a mobile device (such as a mobile phone), desktop computer, laptop computer, email/messaging device, tablet computer, or similar device that may be configured to perform the functions described herein. Generally, the computing device 700 may be any type of computing device or transmitter that is configured to transmit data or receive data in accordance with methods and functions described herein.

The computing device 700 may include an interface 702, a wireless communication component 704, a cellular radio communication component 706, a global positioning system (GPS) receiver 708, sensor(s) 710, data storage 712, and processor(s) 714. Components illustrated in FIG. 7 may be linked together by a communication link 716. The computing device 700 may also include hardware to enable communication within the computing device 700 and between the computing device 700 and other computing devices (not shown), such as a server entity. The hardware may include transmitters, receivers, and antennas, for example.

The interface 702 may be configured to allow the computing device 700 to communicate with other computing devices (not shown), such as a server. Thus, the interface 702 may be configured to receive input data from one or more computing devices, and may also be configured to send output data to the one or more computing devices. The interface 702 may be configured to function according to a wired or wireless communication protocol. In some examples, the interface 702 may include buttons, a keyboard, a touchscreen, speaker(s) 718, microphone(s) 720, and/or any other elements for receiving inputs, as well as one or more displays, and/or any other elements for communicating outputs.

The wireless communication component 704 may be a communication interface that is configured to facilitate wireless data communication for the computing device 700 according to one or more wireless communication standards. For example, the wireless communication component 704 may include a W-Fi communication component that is configured to facilitate wireless data communication according to one or more IEEE 802.11 standards. As another example, the wireless communication component 704 may include a Bluetooth communication component that is configured to facilitate wireless data communication according to one or more Bluetooth standards. Other examples are also possible.

The cellular radio communication component 706 may be a communication interface that is configured to facilitate wireless communication (voice and/or data) with a cellular wireless base station to provide mobile connectivity to a network. The cellular radio communication component 706 may be configured to connect to a base station of a cell in which the computing device 700 is located, for example.

The GPS receiver 708 may be configured to estimate a location of the computing device 700 by precisely timing signals sent by GPS satellites.

The sensor(s) 710 may include one or more sensors, or may represent one or more sensors included within the computing device 700. Example sensors include an accelerometer, gyroscope, pedometer, light sensor, microphone, camera(s), infrared flash, barometer, magnetometer, W-Fi, near field communication (NFC), Bluetooth, projector, depth sensor, temperature sensor, or other location and/or context-aware sensors.

The data storage 712 may store program logic 722 that can be accessed and executed by the processor(s) 714. The data storage 712 may also store data collected by the sensor(s) 710, or data collected by any of the wireless communication component 704, the cellular radio communication component 706, and the GPS receiver 708.

The processor(s) 714 may be configured to receive data collected by any of sensor(s) 710 and perform any number of functions based on the data. As an example, the processor(s) 714 may be configured to determine one or more geographical location estimates of the computing device 700 using one or more location-determination components, such as the wireless communication component 704, the cellular radio communication component 706, or the GPS receiver 708. The processor(s) 714 may use a location-determination algorithm to determine a location of the computing device 700 based on a presence and/or location of one or more known wireless access points within a wireless range of the computing device 700. In one example, the wireless location component 704 may determine the identity of one or more wireless access points (e.g., a MAC address) and measure an intensity of signals received (e.g., received signal strength indication) from each of the one or more wireless access points. The received signal strength indication (RSSI) from each unique wireless access point may be used to determine a distance from each wireless access point. The distances may then be compared to a database that stores information regarding where each unique wireless access point is located. Based on the distance from each wireless access point, and the known location of each of the wireless access points, a location estimate of the computing device 700 may be determined.

In another instance, the processor(s) 714 may use a location-determination algorithm to determine a location of the computing device 700 based on nearby cellular base stations. For example, the cellular radio communication component 706 may be configured to identify a cell from which the computing device 700 is receiving, or last received, signal from a cellular network. The cellular radio communication component 706 may also be configured to measure a round trip time (RTT) to a base station providing the signal, and combine this information with the identified cell to determine a location estimate. In another example, the cellular communication component 706 may be configured to use observed time difference of arrival (OTDOA) from three or more base stations to estimate the location of the computing device 700.

In some implementations, the computing device 700 may include a device platform (not shown), which may be configured as a multi-layered Linux platform. The device platform may include different applications and an application framework, as well as various kernels, libraries, and runtime entities. In other examples, other formats or operating systems may operate the computing g device 700 as well.

The communication link 716 is illustrated as a wired connection; however, wireless connections may also be used. For example, the communication link 716 may be a wired serial bus such as a universal serial bus or a parallel bus, or a wireless connection using, e.g., short-range wireless radio technology, or communication protocols described in IEEE 802.11 (including any IEEE 802.11 revisions), among other possibilities.

The computing device 700 may include more or fewer components. Further, example methods described herein may be performed individually by components of the computing device 700, or in combination by one or all of the components of the computing device 700.

Many other uses and alternatives of the disclosure will become apparent from the foregoing teachings. In this detailed description, numerous examples have been set forth to provide a thorough understanding of the described embodiments. On the other hand, some well-known features have not been described in detail in order to not obscure the description.

A person skilled in the art in view of this description, taken as a whole, will be able to implement various preferred embodiments. However, the specific preferred embodiments disclosed and illustrated herein are not to be considered in a limiting sense. Indeed, it should be readily apparent to those skilled in the art that what is described herein may be modified in numerous ways. Such ways can include equivalents to what is described herein. In addition, embodiments may be practiced in combination with other systems. The following claims define certain combinations and sub-combinations of elements, features, steps, and/or functions, which are regarded as novel and non-obvious. Additional claims for other combinations and sub-combinations may be presented in this or a related document.

What is claimed is:

1. A reconciliation system, comprising:
a classification module programmed to receive raw data that includes a plurality of data sets, each data set comprising a plurality of records wherein a substantial number of records in a first data set have at least one match partner in a second data set, the first data set conforming with a first system, the second data set conforming with a second system, the first and second systems having different data structures,
the classification module being further configured to analyze the plurality of data sets to identify features of the records within each data set and to use a machine learning model to identify useful features from within those features,
the classification module being further configured to group the records into tranches based on whether the records exhibit the useful features, the classification module being still further configured to perform a classification operation on the records within each tranche to identify the match partners.

2. The reconciliation system recited in claim 1, wherein at least one of the first and second systems comprises a financial system.

3. The reconciliation system recited in claim 1, wherein at least one of the first and second systems comprises an operational system.
